(19) United States
(12) Patent Application Publication
(10) Pub. No.: US 2026/0017018 A1
(43) Pub. Date: Jan. 15, 2026

(54) METHODS AND SYSTEMS FOR SECURE ARITHMETIC EQUALITY AND COMPARISON USING QUADRATIC RESIDUES

(71) Applicant: Algemetric, Inc., Colorado Springs, CO (US)

(72) Inventors: Gaetan Delavignette, Colorado Springs, CO (US); Luke E. Harmon, Colorado Springs, CO (US)

(73) Assignee: Algemetric, Inc., Colorado Springs, CO (US)

(21) Appl. No.: 19/264,845

(22) Filed: Jul. 9, 2025

Related U.S. Application Data
(60) Provisional application No. 63/669,108, filed on Jul. 9, 2024.

(51) Int. Cl. G06F 7/499

(52) U.S. Cl. CPC G06F 7/49963

(57) ABSTRACT

Disclosed are methods and system for providing secure arithmetic equality and comparison using probabilistic rounding in the domain of Farey rationals with quadratic residues for a Multi-Party Computation (MPC) system. Embodiments securely provide for evaluation of encoded rational numbers for arithmetic equality equal to zero or not, probabilistic modulo of two rational numbers, probabilistic modulo of a rational number by a public value of two, a test for whether a rational number is greater-than-zero for quadratic residues and a general greater-than-zero test for a rational number which are quadratic non-residues.

### CROSS-REFERENCE TO RELATED APPLICATIONS

This application is based upon and claims the benefit of U.S. provisional application Ser. No. 63/669,108, filed Jul. 9, 2024, entitled “Secure Arithmetic Equality and Comparison Using Quadratic Residues,” all of which is also specifically incorporated herein by reference for all that it discloses and teaches.

### BACKGROUND OF THE INVENTION

The advancement of science is possible when knowledge is shared and information is exchanged in a seamless manner. In a world where many businesses rely on information as their main assets, analysis over data is a crucial competitive advantage. Consequently, the amount of data processed and stored will continue to increase, creating a demand for virtualized services. To this end, some applications can be provided as cloud computing resources including Internet of Things (IoT), machine learning, virtual reality (VR) and blockchain. As a result, concerns about custody and privacy of data are on the rise.

Modern concealment/encryption employs mathematical techniques that manipulate positive integers or binary bits. Asymmetric concealment/encryption, such as RSA (Rivest-Shamir-Adleman), relies on number theoretic one-way functions that are predictably difficult to factor and can be made more difficult with an ever-increasing size of the encryption keys. Symmetric encryption, such as DES (Data Encryption Standard) and AES (Advanced Encryption Standard), uses bit manipulations within registers to shuffle the concealed text/cryptotext/ciphertext to increase “diffusion” as well as register-based operations with a shared key to increase “confusion.” Diffusion and confusion are measures for the increase in statistical entropy on the data payload being transmitted. The concepts of diffusion and confusion in encryption are normally attributed as first being identified by Claude Shannon in the 1940s. Diffusion is generally thought of as complicating the mathematical process of generating unencrypted (plain text) data from the encrypted (cryptotext/ciphertext) data, thus, making it difficult to discover the encryption key of the concealment/encryption process by spreading the influence of each piece of the unencrypted (plain) data across several pieces of the concealed/encrypted (cryptotext) data. Consequently, an encryption system that has a high degree of diffusion will typically change several characters of the concealed/encrypted (cryptotext/ciphertext) data for the change of a single character in the unencrypted (plain) data making it difficult for an attacker to identify changes in the unencrypted (plain) data. Confusion is generally thought of as obscuring the relationship between the unencrypted (plain) data and the concealed/encrypted (cryptotext) data. Accordingly, a concealment/encryption system that has a high degree of confusion would entail a process that drastically changes the unencrypted (plain) data into the concealed/encrypted (cryptotext/ciphertext) data in a way that, even when an attacker knows the operation of the concealment/encryption method (such as the public standards of RSA, DES, and/or AES), it is still difficult to deduce the encryption key.

Homomorphic Encryption is a form of encryption that allows computations to be carried out on concealed ciphertext as it is concealed/encrypted without decrypting the ciphertext that generates a concealed/encrypted result which, when decrypted, matches the result of operations performed on the unencrypted plaintext.

The word homomorphism comes from the ancient Greek language: [symbol] (homos) meaning “same” and μoρφ\acute{η} (morphe) meaning “form” or “shape.” Homomorphism may have different definitions depending on the field of use. In mathematics, for example, homomorphism may be considered a transformation of a first set into a second set where the relationship between the elements of the first set are preserved in the relationship of the elements of the second set.

For instance, a map f between sets A and B is a homomorphism of A into B if

$$f ( {a}_{1} op {a}_{2} ) = f ( {a}_{1} ) op f ( {a}_{2} ) \vert {a}_{1} , {a}_{2} ∈ A$$

where “op” is the respective group operation defining the relationship between A and B.

More specifically, for abstract algebra, the term homomorphism may be a structure-preserving map between two algebraic structures such as groups, rings, or vector spaces. Isomorphisms, automorphisms, and endomorphisms are typically considered special types of homomorphisms. Among other more specific definitions of homomorphism, algebra homomorphism may be considered a homomorphism that preserves the algebra structure between two sets.

Multi-Party Computation (MPC) is a cryptographic technique that allows multiple parties to jointly compute a function over their private data without revealing it to each other. MPC works by using complex encryption to distribute computation between multiple parties. MPC enables parties to share data for computing tasks and obtain the output, but no party learns anything about others' data or secrets.

### SUMMARY OF THE INVENTION

An embodiment of the present invention may comprise a method for Multi-Party Computation (MPC) arithmetic comparison on a Multi-Party Computation (MPC) system of rational data encoded in a domain of Farey rationals, the method comprising: encoding by a first data server computing device a rational number into an encoded integer corresponding to the rational number as an encode function in the domain of Farey rationals; sending by the first data server computing device the encoded integer to a second data server computing device; computing by the second data server computing device an arithmetic comparison that has an arithmetic comparison result as a function of a FuzzyRound operation, quadratic residues, and the encoded integer; and sending by the second data server computing device the result encoded integer to a third data server computing device for use in additional computations and logic.

An embodiment of the present invention may further comprise an arithmetic comparison system that operates as part of a Multi-Party Computation (MPC) system, the arithmetic comparison system comprising: a first data server computing device that encodes a rational number into an encoded integer corresponding to the rational number as an encode function in the domain of Farey rationals and sends the encoded integer to a second data server computing device; and the second server computing device that computes an arithmetic comparison that has an arithmetic comparison result as a function of a FuzzyRound operation, quadratic residues, and the encoded integer and sends the result encoded integer to a third data server computing device for use in additional computations and logic.

### BRIEF DESCRIPTION OF THE DRAWINGS

In the drawings,

FIG. 1 is a block diagram of the hardware implementation for an embodiment.

FIG. 2 is a flow chart of operations for an embodiment.

### DETAILED DESCRIPTION OF THE EMBODIMENTS

In multi-party computation, the problem of efficiently and securely comparing two shared secrets has been the focus of volumes of research. Of particular interest has been the problem of finding protocols that “play well” with so-called arithmetic protocols. This is because arithmetic operations (+, ×) are more frequent than Boolean operations in most applications, and are much more efficient than their Boolean counterparts. However, all of the proposed comparison protocols work by enabling Boolean circuits within the arithmetic domain and rely on the binary representations (e.g. two-complement representation) of their inputs. In this work, we present the first (to our knowledge) arithmetic equality and comparison protocols for secret sharing-based multi-party computation which do not depend on the binary representation of their inputs. Instead, they use a novel probabilistic truncation protocol, and a quadratic residue test protocol introduced by Nishide and Ohta. Our protocols require very few invocations of core operations like multiplication and reconstruction, and the number of these invocations is independent of input size. For example, in its online phase our equality protocol requires only four multiplications and three reconstructions. In practice this means that increasing the input size only requires the size of the field to increase. Moreover, all of our protocols are constant-round when realized by a particular secret-sharing scheme such as Shamir's.

### 1 Introduction

In 1982, researchers introduced the millionaires' problem. In this well-known problem Alice and Bob are two millionaires who are trying to determine which of them is wealthier without revealing their wealth. Through this problem and its solution researchers formally introduced secure computation. Secure computation allows the evaluation of functions on private data without revealing those data. A common technique for secure computation, and the focus of this patent application disclosure, is Multi-Party Computation (MPC). In MPC, n distrusting parties (n≥2) each with data d₁, . . . , dₙ want to evaluate a function F(d₁, . . . , dₙ) on their data without revealing any information about the data other than the output of the function.

Multiple of these works depend on secret sharing for their protocols and their subsequent implementations. Secret sharing appeared a few years ahead of secure computation, it was introduced independently by Shamir and Blakley in 1979. Traditionally, in secret sharing each of n parties Pᵢ receives a piece (share) of the private data (secret) being shared. Each of these shares being indistinguishable from a random value. Any authorized set of parties must have the ability to reconstruct the secret while unauthorized sets of parties should not be able to learn any information about the secret. When applied to secure computation the authorized sets can perform operations on the secrets and reconstruct them through communications with one another (e.g., sending/receiving shares, creating and sending new shares, etc.). Shamir introduced a technique to share secrets using polynomial interpolation over finite fields. Another well-known technique to share secrets is Additive Secret Sharing, which relies on the fact that a sum of a fixed element and uniformly random element in a finite field is indistinguishable from uniformly random.

There have been volumes of follow-up work aimed at improving the performance of protocols that securely compare (“<” or “=”) secret-shared values. Many of these use so-called garbled circuits and evaluate comparisons as Boolean circuits. While garbled circuit-based solutions can be very efficient in evaluating secure comparisons, they tend to be much less efficient for arithmetic operations (i.e. operations on integers). In contrast, MPC realized over a large ring or field suffers from the opposite problem: arithmetic operations are very efficient, but comparisons are very inefficient. A secure equal-to-zero protocol which works over finite fields has been introduced, but it suffered from the constraint of requiring the field to have small characteristic. Researchers finally made comparisons practical over large prime-order fields by introducing a constant-round “bit-decomposition” protocol for converting a sharing of a∈ [symbol] ₚ to sharings of the bits of a viewed as elements of [symbol] ₚ. Their protocol enabled equality and comparison of integers (field elements) to be performed bitwise. Despite impressive progress in efficiency, equality and comparison protocols (specifically comparison) which do not rely on the binary representation of the inputs have been elusive.

### 1.1 Our Contributions

We introduce two novel arithmetic protocols for securely computing equal-to-zero and greater-than-zero with constant invocations of core protocols like multiplication. These protocols heavily rely on two other protocols. One is a quadratic residue test that securely computes the Legendre symbol of a shared integer. The other is a novel protocol for probabilistic rounding of Farey rationals. The latter enables equal-to-zero by leveraging patterns of quadratic residues, and enables greater-than-zero via two mod reduction protocols. Of course, the equal-to-zero and greater-than-zero protocols trivially enable comparison of two nonzero values; just subtract the values and run the protocol on their difference.

### Organization.

Section 2 introduces notation, linear secret sharing schemes, and our notion of security via the so-called arithmetic black box model.

In Section 3, we introduce the Farey rationals, discuss some relevant prior work which used them, and present the quadratic residue test protocol which enables our comparison protocols.

Section 4 presents our first new protocol—FuzzyRound—and proves some important results about correctness and security.

Section 5 introduces the equal-to-zero protocol, proves its correctness, and then shows that the quadratic residue pattern required by the protocol occurs in all sufficiently large primes. It finishes with a discussion of parameters.

Section 6 begins by introducing the mod reduction protocols used by the greater than-zero protocol, and then presents and proves the correctness of the protocol. Like the preceding section, it ends with a discussion of parameters.

The security of our protocols is proved in Section 7. The heavy lifting is done by lemma 3 in section 4.

Section 8 provides some example field sizes that allow our protocols to work with various inputs, and then briefly discusses fixed-point numbers and how our protocols are compatible with fixed-point arithmetic.

Section 9 uses 2-out-of-3 Shamir Secret Sharing along with specific core protocols to estimate the online round and communication complexities of our protocols.

### 2 Preliminaries

Notation. For a positive integer m, [symbol] /m [symbol] denotes the ring of integers modulo m. In case m is prime, we write [symbol] ₘ. The elements of [symbol] /m [symbol] will be represented by integers 0, 1, . . . , m−1. We use y←A(x) to denote that a randomized algorithm A on input x outputs y. If A is deterministic, we simply write y=A(x). We use r [symbol] S to mean that r is selected uniformly at random from the set S. If a protocol has no argument, e.g. [symbol] ( ), then the protocol takes no inputs. σ always denotes a statistical security parameter.

Linear Secret Sharing Schemes (LSSS). A sharing of x∈ [symbol] ₚ among n parties will be denoted [x]=([x]₁, [x]₂, . . . , [x]ₙ), so that the i^{th} party receives the share [x]ᵢ. [x]±[y], [x]·[y] mean that each party adds/subtracts or multiplies their share of x with their share of y. Execution of LSSS protocols can be separated into the synchronous online phase, i.e. the operations which must be performed during the protocol, and the asynchronous offline phase. The offline phase is reserved for tasks that can be performed before the inputs to a particular function—or even the function itself—are known. E.g., generating correlated randomness.

Arithmetic Black Box. In spite of using LSSS for our protocols, we do not specify which LSSS. Instead we use the Arithmetic Black Box (ABB) model introduced by Damgård and Nielson. Under this model, the parties all have access to a functionality [symbol] _{ABB} that allows parties share and reconstruct secrets (Recon), multiply shared secrets (Mult), and perform local operations (addition of shared values, and addition and multiplication of a secret value and a public value). We further assume the parties have access to functionalities that generate: a uniformly random element of [symbol] ₚ, a uniformly random bit viewed as an element of [symbol] ₚ, and a uniformly random integer in [0, 2^{k})⊆ [symbol] ₚ. We denote these protocols by RandInt( ), RandBit( ), and RandInt(k), respectively. We further assume that all randomness needed for a protocol is generated in the offline phase. With this in mind, the complexity of a protocol will be measured in number of invocations of Mult, Recon, and functionalities for generating randomness.

### 2.1 Security

All of our protocols are constructed via clever compositions of Mult, Recon, local operations, and protocols for generating randomness. This means that as long as values which are revealed during a protocol do not leak any information, the protocol inherits the security of [symbol] _{ABB} and the randomness functionalities. This allows our protocols to achieve active security (security against malicious adversaries) by simply assuming all functionalities are realized using actively secure framework (e.g. Verifiable Secret Sharing) which ensures the core protocols are actively secure, and then invoking Canetti's composition theorem which roughly states that a composition of secure protocols yields a secure protocol.

### 3 Building Blocks

Here we review and summarize the prior work on which our protocols rely. As discussed in the introduction, our protocols heavily rely on prior works that use the Farey rationals along with a protocol for securely computing the Legendre symbol of a shared integer. This section first introduces the Farey rationals and the encoder used to map them into a finite field along with some of their important properties, and then presents the protocol for computing the Legendre symbol.

### 3.1 Farey Rationals

The Farey rationals (Also commonly called the Farey fractions, and related to the Farey sequence.) have been used in the context of rational approximations of irrational numbers, error-free computation, and the rational reconstruction problem. The latter asks when is it possible to recover an unknown fraction a/b given a modulus m which is co-prime to b and the value ab⁻¹ mod m. They are defined as the set

$${ℱ}_{N} := \{ x / y : \vert x \vert \leq N , 0 < y \leq N , gcd ( x , y ) = 1 , gcd ( p , y ) = 1 \} ,$$

where N=N(p):=└\sqrt{(p−1)/2}┘, and are simply the set of reduced fractions with numerator and denominator both bounded in absolute value by N. Note that there may be many primes p which yield the same set of Farey rationals. The following lemma collects some important properties of [symbol] _{N}.

Lemma 1. Let p be a prime and N=N(p).
(i) If x/y∈ [symbol] N, then −x/y∈ [symbol] _{N}.
(ii) If x/y∈ [symbol] _{N} is nonzero, then y/x∈ [symbol] _{N}.
(iii) [−N, N]∩ [symbol] ⊆ [symbol] _{N}.
(iv) [symbol] _{N} is not closed under addition and multiplication.

Proof. (i) x/y∈ [symbol] _{N} implies |−x|=|x|≤N, so −x/y∈ [symbol] _{N}. (ii) Let x/y∈ [symbol] _{N} be nonzero. Then x≠0 and |x|, y≤N, so y/x∈ [symbol] _{N}. (iii) If x∈[−N, N]∩ [symbol] then clearly x=x/1∈ [symbol] _{N}. (iv) Since [symbol] _{N} is simply a set of rationals, it is not closed under the usual +,×. E.g. N∈ [symbol] _{N}, but N+N=2N∉ [symbol] _{N}.

### 3.2 A Somewhat Homomorphic Encoding

Harmon et al defined a rational encoder for homomorphic encryption based on the aforementioned rational reconstruction problem. Their encoding maps elements of [symbol] _{N(p)} to the finite field [symbol] ₚ, and is defined by enc(x/y)=xy⁻¹ mod p. The decoding dec can be computed efficiently using a slight modification of the Extended Euclidean Algorithm. enc is somewhat homomorphic in the sense that it is homomorphic with respect to +,× as long as the composition of operands remains in [symbol] _{N}

$$( E . g . , enc ( \frac{{x}_{0}}{{y}_{0}} + \frac{{x}_{1}}{{y}_{1}} ) = enc ( \frac{{x}_{0}}{{y}_{0}} ) + enc ( \frac{{x}_{1}}{{y}_{1}} ) iff \frac{{x}_{0}}{{y}_{0}} , \frac{{x}_{1}}{{y}_{1}} , \frac{{x}_{0}}{{y}_{0}} + \frac{{x}_{1}}{{y}_{1}} ∈ {ℱ}_{N} .$$

We summarize important properties of enc with the following lemma.

Lemma 2. Let p be a prime, N=N(p), and enc, dec be the encode and decode maps, respectively.
(i) If z∈[−N, N]∩ [symbol] , then enc(z)=z.
(ii) enc is somewhat homomorphic w.r.t. addition and multiplication of Farey rationals. In particular, if *∈{+,×} and A, B, A*B∈ [symbol] _{N}, then

$$dec ( enc ( A ) * enc ( B ) ) = A * B .$$

Proof. (i) Let z∈[−N, N]∩ [symbol] . By definition, enc(z)=z∈ [symbol] ₚ. Of course, enc(z) is a field element, and so depends on the representatives chosen for [symbol] ₚ. E.g., if we use {0, 1, . . . , p−1}, then enc(1)=1 and enc(−1)=p−1.

### 3.3 Protocols for Arithmetic Over the Farey Rationals

We briefly review the protocols for addition, subtraction, multiplication, and division of Farey rationals using SSS or AddSS introduced by Harmon and Delavignette in previous work. Their family of protocols, which they call Mercury, is defined over the Farey Rationals via the aforementioned somewhat homomorphic encoding, allowing it to leverage existing protocols defined over [symbol] ₚ. The Mercury division, in particular, relies on the fact that [symbol] _{N} is closed under reciprocals lemma 1(ii). This property allows ÷ to be performed very efficiently as multiplication with a reciprocal. All of the Mercury protocols are distinguished by the prefix “Hg”. However, ignoring the encoder, addition, subtraction, and multiplication are identical to their counterparts realized by [symbol] _{ABB}, so we choose to only include the prefix for division. I.e., division is denoted by HgDiv.

The addition and subtraction protocols can be performed locally, and the multiplication is identical to Mult. HgDiv requires two invocations of Mult, one invocation of Recon, and one invocation of RandInt( ).

All of these protocols are constrained by the fact that [symbol] _{N} is not closed under +,×. This means that in practice they must take the domain of secrets to be a subset [symbol] ⊆ [symbol] _{N} that is chosen so that any desired compositions of elements of [symbol] remain in F_{N}. The choice of [symbol] depends on the secrets, and the functions that must be computed on the shared secrets. We will elaborate later on how [symbol] should be chosen.

### 3.4 A Quadratic Residue Test Protocol

It requires a prime secret sharing modulus which is congruent to 3 modulo 4, and outputs the Legendre symbol of a∈ [symbol] , which is defined as

$$( \frac{a}{p} ) := \{ \begin{matrix}1 , & if a is a quatratic residue modulo p \\ - 1 , & if a is a quatratic non - residue modulo p \\ 0 , & if a = 0\end{matrix} \qquad Eq . 1$$

Protocol 1: Secure quadratic residue test.

```
Inputs. Shares of nonzero a ∈ [symbol]  ₚ.
    $[ ( \frac{a}{p} ) ] ← Legendre ( [ a ] ) .$
1. [b] ← RandBit( )
2. [s] = 2[b] − 1;
3. [r] ← RandInt( );
4. [r²] = Mult([r], [r]);
5. [sr²] = Mult([s], [r²]);
6. [sr²a] = Mult([sr²], [a]);
7. sr²a = Recon([[ar²a]); // if sr²a = 0, the parties restart from Step 4.
8.  ${s}^{′} = ( \frac{s {r}^{2} a}{p} ) ;$
9.  $[ ( \frac{a}{p} ) ] = {s}^{′} [ s ] ;$
10.  $return [ ( \frac{a}{p} ) ] .$
Invocations. Online: 1 Mult, 1 Recon.
              Offline: 2 Mult, 1 RandBit( ), 1 RandInt( ).
```

### 4 FuzzyRound: A Probabilistic Rounding Protocol

This protocol is the fundamental component of our equality and comparison protocols. FuzzyRound approximates a/b∈ [symbol] _{N} by c/B^{k}∈ [symbol] _{N} for some positive integer base B and nonnegative integer k. The example below illustrates the idea of the protocol by performing the truncation on un-shared values.

Example 1. Given a/10⁸=314159265/10⁸=3.14159265, suppose we want to truncate to four decimal places of precision. On un-shared values, the protocol proceeds as follows:
(i) Secret to be truncated: 3.14159265;
(ii) Scale secret by 10⁸/10⁴=10⁴: 31415.9265;
(iii) Generate random integer masks r, s: say r=537914 and s=7116;
(iv) Add r+10⁻⁴s to the scaled secret: 31415.9265+537914.7116=569330.6381;
(v) Round down to the nearest integer: └569330.6381┘=569330;
(vi) Subtract r from the rounded value: 569330−537914=31416;
(vii) Scale result by 10⁻⁴: 31416·10⁻⁴=3.1416.

This yields 31416/10⁴≈314159265/10⁸, as desired. Notice that 314159265//10⁸−31416//10⁴=9265/10⁸<10⁴/10⁸=1/10⁴.

We assume that at the start of the protocol each party has: B, k, and shares of enc(a/b). For notational simplicity, we will write [a/b] instead of [enc(a/b)].

Protocol 2: Secure probabilistic rounding of Farey rationals.

```
Inputs. The fraction x/y ∈ [symbol]  _{N} to be rounded and its encoding enc(x/y) ∈ [symbol]  ₚ. An
          integer base B, a precision k, and a security parameter σ.
$Constraints . {2}^{ℓ} \geq {max}_{x} \{ \vert x \vert \} {B}^{k} and {2}^{σ} N \geq {2}^{ℓ} + {2}^{ℓ} {max}_{y} \{ \vert y \vert \} + {max}_{y} \{ \vert y \vert \} .$
      [z/B^{k}] ← FuzzyRound([x/y], B, k, σ).
1. [r] ← RandInt( [symbol] ) and [r′] ← RandInt(σ);
2. [xB^{k}/y] = B^{k} · [x/y] and = [r′/2^{σ}] = 1/2^{σ} · [r′];
3. [xB^{k}/y + r + r′/2^{σ}] = [xB^{k}/y] + [r] + [r′/2^{σ}];
4. enc(xB^{k}/y + r + r′/2^{σ}) = Recon[xB^{k}/y + r + r′/2^{σ}]);
5. xB^{k}/y + r + r′/2^{σ} = dec(enc(xB^{k}/y + r + r′/2^{σ}));
6. compute [xB^{k}/y] + b + r = └xB^{k} /y + r + r′/2^{σ}┘; // Note that b ∈ {0,1}
7. [└xB^{k}/y┘ + b] = enc(└xB^{k}/y┘ + b + r ) − [r];
8. [└xB^{k}/y┘ · B^{-k} + bB^{-k}] = B^{-k} · [└xB^{k}/y┘ + b];
9. return[z/B^{k}] = [└xB^{k}/y┘ · B^{-k} + bB^{-k}].
Invocations. Online: 1 Recon.
              Offline: 1 RandInt( [symbol] ), 1 RandInt(σ).
```

The constraint [symbol] ≥η+log₂(B)k is required for the proof of security, and N≥ [symbol] + [symbol] +2^{δ+σ} ensures that computations do not overflow [symbol] _{N} during the execution of FuzzyRound.

Observe that FuzzyRound probabilistically rounds up or down, depending on the values of r′, x/y, B^{k}, and κ. In particular, it rounds down whenever xB^{k}/y+r′/2^{κ} remains between └xB^{k}/y┘ and ┌xB^{k}/y┐. Proposition 1 provides details.

Proposition 1. Let frac=xB^{k}/y−└xB^{k}/y┘∈┌0, 1) be the fractional part of xB^{k}/y. Then FuzzyRound
(i) rounds down with probability 1−frac, and
(ii) and rounds up with probability frac.

Proof. Recall that b∈{0, 1} the bit from step (6) of FuzzyRound protocol. Clearly FuzzyRound rounds down if and only if

$$⌊ \frac{{xB}^{k}}{y} ⌋ \leq \frac{{xB}^{k}}{y} + \frac{{r}^{′}}{{2}^{κ}} < ⌈ \frac{{xB}^{k}}{y} ⌉ , \qquad Eq . 2$$

and Equation 2 holds precisely when b=0. Note that if y divides xB^{k}, then Pr(b=0)=1 and frac=0. Suppose yłxB^{k}, whence ┌xB^{k}/y┐≠└xB^{k}/y┘. Then Equation 2 implies

$$\begin{matrix}0 \leq \frac{x {B}^{k}}{y} - ⌊ \frac{x {B}^{k}}{y} ⌋ + \frac{{r}^{′}}{{2}^{κ}} < ⌈ \frac{x {B}^{k}}{y} ⌉ - ⌊ \frac{x {B}^{k}}{y} ⌋ \\ 0 \leq 𝔣𝔯𝔞𝔠 + \frac{{r}^{′}}{{2}^{κ}} < 1 \\ 0 \leq {r}^{′} < {2}^{κ} ( 1 - 𝔣𝔯𝔞𝔠 ) .\end{matrix}$$

Since r′ is selected from the uniform distribution over [0, 2^{κ}), it follows that Pr(b=0)=2^{κ}(1−frac)/2^{κ}=1−frac and Pr(b=1)=1−Pr(b=0)=frac. This completes the proof.

### 4.1 Correctness and Security

Proposition 2 (Correctness). The truncation protocol FuzzyRound is correct in the sense that, for input x/y and output z/B^{k}=└xB^{k}/y┘/B^{k}+b/B^{k},

$$\vert \frac{x}{y} - \frac{z}{{B}^{k}} \vert < \frac{1}{{B}^{k}}$$

Moreover, if x=0, then z=0.

Proof. For b∈{0,1}

$$\vert \frac{x}{y} - ( \frac{⌊ \frac{x {B}^{k}}{y} ⌋}{{B}^{k}} + \frac{𝔟}{{B}^{k}} ) \vert = \vert \frac{x}{y} - \frac{⌊ \frac{x {B}^{k}}{y} ⌋}{{B}^{k}} - \frac{𝔟}{{B}^{k}} \vert \cdot \frac{y {B}^{k}}{y {B}^{k}} = \vert {xB}^{k} - y ⌊ \frac{x {B}^{k}}{y} ⌋ - 𝔟 y \vert \cdot \frac{1}{y {B}^{k}} = \vert ( {xB}^{k} mod y ) - 𝔟 y \vert \cdot \frac{1}{y {B}^{k}} < y \cdot \frac{1}{y {B}^{k}} = \frac{1}{{B}^{k}}$$

If x=0, then the bit b in step 6 of FuzzyRound is 0. It follows that z=0. This completes the proof.

We next prove a lemma which will allow us to show that FuzzyRound is secure. The formal security will be discussed later along with the security of the rest of our protocols.

Lemma 3. Let x/y∈ [symbol] _{N} and B, k be integers. Further, let r [symbol] [0, [symbol] ), and r′ [symbol] [0, 2^{σ}). If [symbol] _{secret} is the distribution of the random variable S=xB^{k}/y+r+r′/2^{σ} and [symbol] is the distribution of the random variable R=r+r′/2^{σ}, then the statistical distance between [symbol] and [symbol] _{secret} is negligible in σ.

Proof. We start by showing that D is uniform over its range. It suffices to show that the random variable 2^{σ}R=2^{σ}(r+r′/2^{σ})=r2^{σ}+r′ is uniform. If r₀2^{σ}+r′₀=r₁2^{σ}+r′₁, then (r₀−r₁)2^{σ}=r′₁−r′₀. Since 0≤|r′₁−r′₀|<2^{σ}, r′₀=r′₁ and r₀=r₁. This means the distribution of 2^{σ}R is uniform, whence the distribution of R is also uniform. That is, since |range(2^{σ}R)|=|range(R)| and range(2^{σ}R)=[0, [symbol] ), Pr(R=i)=1/|range(R)|=1/ [symbol] .

Notice that S=xB^{k}/y+r+r′/2^{σ} is simply the random variable obtained by shifting the distribution of R by xB^{k}/y to the left if x<0 and to the right if x>0. Without loss of generality, suppose x>0. With this shift in mind, we split range(R)∪range(S)=[0, xB^{k}/y+ [symbol] ) into three subintervals: [0, xB^{k}/y), [xB^{k}/y, [symbol] ), and [ [symbol] , xB^{k}/y+ [symbol] ). It is clear that

$$\begin{matrix}( i ) & i ∈ [ 0 , {xB}^{k} / y ) ⟹ Pr ( R = i ) = 1 / {2}^{ℓ + σ} and Pr ( S = i ) = 0 , \\ ( ii ) & i ∈ [ x {B}^{k} / y , {2}^{ℓ + σ} ) ⟹ Pr ( R = i ) = P r ( S = i ) , and \\ ( iii ) & i ∈ [ {2}^{ℓ + σ} , {xB}^{k} / y + {2}^{ℓ + σ} ) ⟹ Pr ( R = i ) = 0 and Pr ( S = i ) = 1 / {2}^{ℓ + σ} .\end{matrix}$$

We now show that the statistical distance between R and S is bounded by a negligible function of the statistical security parameter σ.

$$2 Δ ( R , S ) = {\sum }_{i ∈ range ( R ) ⋃ range ( S )} \vert Pr ( R = i ) - P r ( S = i ) \vert = \frac{2 x {B}^{k} / y}{{2}^{ℓ + σ}} \leq \frac{2 \cdot {2}^{ℓ}}{{2}^{ℓ + σ} y} , since ℓ \geq η + {log}_{2} ( B ) k = \frac{2}{{2}^{σ} y}$$

### So

$$Δ ( R , S ) < \frac{1}{{2}^{σ} y} ,$$

which is negligible in σ, as desired.

Even though this is not the focus of this work, we note that pairing FuzzyRound with the Mercury protocols yields efficient fixed-point protocols for +, ·, −, and ÷. The resulting division protocol, in particular, is better than state-of-the-art protocols in terms of both round and communication complexity.

### 5 Arithmetic Equality

With a well-chosen prime modulus, we can use FuzzyRound along with properties of quadratic residues to build a protocol which outputs 1 if its input is zero, and 0 otherwise.

Proposition 3. Let a∈ [symbol] _{N} be an integer such that a²+1<N and f=FuzzyRound ([a²/a²+1], 2, 1, σ) is defined, then

$$f = \{ \begin{matrix}0 & if a = 0 \\ 1 / 2 or 1 , & if a \neq 0\end{matrix} \qquad Eq . 3$$

Proof. Let α=a²/(a²+1). If a=0, then α=0, and Proposition 2 implies that f=0. Suppose a≠0. In this case, ½≤α<1. Again, by Proposition 2, −½<f−α<½. Combining these two inequalities yields 0<f<3/2. The result follows since f must be a multiple of ½.

For a prime p, recall that an integer a is a quadratic residue modulo p (qr) if and only if there is an integer b such that a=b² mod p. If no such integer exists, we say a is a quadratic non-residue modulo p (qnr). With this in mind, we may now introduce the equal-to-zero protocol.

Protocol 3: Secure equal-to-zero.

Inputs. Shares of (the encoding of) an integer a ∈ [symbol] _{N}, an integer α, and a security parameter
σ.
Constraints. a needs to be small enough relative to N so that a² + 1 < N and
FuzzyRound([a²/a² + 1], 2, 1, σ) is defined, and α is qr and α + 1, α + 2 are qnr.

| | |
|---|---|
| | [a =^{?} 0] ← EQZ([a], α, σ) |
| 1. | [a²] = Mult([a], [a]); |
| 2. | [a² + 1] = [a²] + 1; |
| 3. | [d] = HgDiv([a²], [a² + 1]); |
| 4. | [f] ← FuzzyRound([d], 2, 1, σ); |
| 5. | [s] = 2[f] + α; |
| 6. | [ [symbol] ] = Legendre([s]); |
| 7. | [ [symbol] ] = ([ [symbol] ] + 1)/2; |
| 8. | return [ [symbol] ] = [a =^{?} 0]. |
| Invocations. | Online: 4 Mult, 3 Recon. |
| | Offline: 2 Mult, 2 RandInt( ), 1 RandBit ( ), 1 RandInt( [symbol] ), 1 Randint(σ). |

Theorem 1. The equal-to-zero protocol EQZ is correct.

Proof. First notice that by Proposition 3, f=0 if a=0, and f=½ or 1 if a≠0. So then s=α if a=0 and s=α+1 or α+2 if a≠0. Since α is qr and α+1, α+2 are qnr, [symbol] =1 if a=0 and [symbol] =−1 if a≠0. Consequently, z=1 if a=0 and z=0 if a≠0, as desired.

We now pivot to the question of finding a suitable α for EQZ. A well-studied question in number theory regards patterns of quadratic residues modulo a given prime. In particular, one may fix a pattern, e.g. (qr, qnr, qnr), and ask how many α∈ [symbol] ₚ satisfy: α is qr, and α+1, α+2 are qnr. Note that the pattern should not “wrap around” p. We will consider the case where p=3 mod 4 and the pattern is (qr, qnr, qnr). With minor changes, EQZ also works when the pattern is (qr, qnr, qnr). First, we collect a few well-known properties of quadratic residues and the Legendre symbol

$$( \frac{\cdot }{p} ) .$$

Lemma 4. Let p=3 mod 4 be prime,

$$𝒳 ( x ) = \frac{x}{p} ,$$

and f∈ [symbol] ₚ[x].
(i) For all x, y∈ [symbol] ₚ, [symbol] (xy)= [symbol] (x) [symbol] (y).
(ii)

$${\sum }_{x = 0}^{p - 1} 𝒳 ( x + c ) = 0$$

for all c∈ [symbol] ₚ.
(iii) If f(−x)=−f(x) for all x∈ [symbol] ₚ, then

$${\sum }_{x = 0}^{p - 1} 𝒳 ( f ( x ) ) = - 1 .$$

(iv) If f is quadratic and monic with nonzero discriminant, then

$${\sum }_{x = 0}^{p - 1} 𝒳 ( f ( x ) ) = - 1 .$$

We now show that almost all primes—certainly the ones large enough to be of use for EQZ—have a pattern of the form (qr, qnr, qnr).

Proposition 4. If p=3 mod 4 is prime, then the number N(p) of a∈ [symbol] ₚ such that (a, a+1, a+2) is (qr, qnr, qnr) satisfies N(p)≥(p−3)/8.

Proof. Again, let

$$𝒳 ( x ) = ( \frac{x}{p} ) .$$

Put εᵢ= [symbol] (a+i), i=0, 1, 2.

Suppose (a, a+1, a+2) is (qr, qnr, qnr). Notice that in this implies ε₀=1 and ε₁=ε₂=−1. Define q(a):=(1+ [symbol] (a))(1− [symbol] (a+1))(1− [symbol] (a+2)), and observe that

$$q ( a ) = \{ \begin{matrix}8 , & if ( a , a + 1 , a + 2 ) is ( qr , qnr , qnr ) \\ 0 , & otherwise\end{matrix} \qquad Eq . 4$$

So the number of a∈ [symbol] ₚ which yield the pattern is

$$N ( p ) = 1 / 8 {\sum }_{a = 0}^{p - 3} q ( a ) .$$

The sum only goes to p−3 because the pattern cannot wrap around p by definition. Now, multiply out q(a) and use Lemma 4(i) to get

See Section A at the end of this detailed disclosure for proof of Lemma 4.

$$1 + 𝒳 ( a ) - 𝒳 ( a + 1 ) - 𝒳 ( a + 2 ) - 𝒳 ( {a}^{2} + a ) - 𝒳 ( {a}^{2} + 2 a ) + 𝒳 ( {a}^{2} + 3 a + 2 ) + 𝒳 ( a ( a + 1 ) ( a + 2 ) ) . \qquad Eq . 5$$

Now we apply Lemma 4 to the sum of Equation 5 over a=0, 1, . . . , p−3 to obtain a closed form for

$$N ( p ) = {\sum }_{a = 0}^{p - 3} q ( a ) .$$

$${\sum }_{a = 0}^{p - 3} 1 = p - 3.$$

$${\sum }_{a = 0}^{p - 3} 𝒳 ( a ) = {\sum }_{a = 0}^{p - 1} 𝒳 ( a ) - 𝒳 ( p - 2 ) - 𝒳 ( p - 1 ) = 1 + 𝒳 ( 2 ) .$$

$${\sum }_{a = 0}^{p - 3} 𝒳 ( a + 1 ) = {\sum }_{a = 0}^{p - 1} 𝒳 ( a + 1 ) - 𝒳 ( p - 1 ) - 𝒳 ( p ) = 1.$$

$${\sum }_{a = 0}^{p - 3} 𝒳 ( a + 2 ) = {\sum }_{a = 0}^{p - 1} 𝒳 ( a + 2 ) - 𝒳 ( p ) - 𝒳 ( p + 1 ) = - 1.$$

$${\sum }_{a = 0}^{p - 3} 𝒳 ( {a}^{2} + a ) = {\sum }_{a = 0}^{p - 1} 𝒳 ( {a}^{2} + a ) - 𝒳 ( {p}^{2} - 3 p + 2 ) - 𝒳 ( {p}^{2} - p ) = - 1 - 𝒳 ( 2 ) .$$

$${\sum }_{a = 0}^{p - 3} 𝒳 ( {a}^{2} + 2 a ) = {\sum }_{a = 0}^{p - 1} 𝒳 ( {a}^{2} + 2 a ) - 𝒳 ( {p}^{2} - 2 p ) - 𝒳 ( {p}^{2} - 1 ) = 0.$$

$${\sum }_{a = 0}^{p - 3} 𝒳 ( {a}^{2} + 3 a + 2 ) = {\sum }_{a = 0}^{p - 1} 𝒳 ( {a}^{2} + 3 a + 2 ) - 𝒳 ( {p}^{2} - p ) - 𝒳 ( {p}^{2} + p ) = - 1 .$$

The last term requires an easy substitution. First, we see that

$${\sum }_{a = 0}^{p - 3} 𝒳 ( a ( a + 1 ) ( a + 2 ) ) = {\sum }_{a = 0}^{p - 1} 𝒳 ( a ( a + 1 ) ( a + 2 ) ) - 𝒳 ( ( p - 2 ) ( p - 1 ) p ) - 𝒳 ( ( p - 1 ) p ( p + 1 ) ) = {\sum }_{a = 0}^{p - 1} 𝒳 ( a ( a + 1 ) ( a + 2 ) ) .$$

Now replacing a by b−1, we see the latter sum is equivalent to

$${\sum }_{b = 0}^{p - 1} 𝒳 ( ( b - 1 ) b ( b + 1 ) ) .$$

Lemma 4(iii) then implies that

$${\sum }_{b = 0}^{p - 1} 𝒳 ( ( b - 1 ) b ( b + 1 ) ) = 0 .$$

Putting the above computations together yields

$$N ( p ) = 1 / 8 {\sum }_{a = 0}^{p - 3} q ( a ) = ( p + 2 𝒳 ( 2 ) - 1 ) / 8.$$

Since [symbol] (2)=±1, it follows that N(p)≥(p−3)/8, completing the proof.

Corollary 1. Let p=3 mod 4 be prime. If p≥11, then there is at least one a∈ [symbol] ₚ such that (α, α+1, α+2) is (qr, qnr, qnr).

The takeaway is that for any sufficiently large prime p, one can find an α such that (α, α+1, α+2) is (qr, qnr, qnr). For arbitrary primes, we suspect that a small α which yields the pattern can be found because of the apparent randomness of the distribution of quadratic residues. This remains speculation, however. Fortunately, we can provide specific primes which work. Consider, for example, the Mersenne primes 2¹²⁷−1 and 2⁶⁰⁷−1. For both primes, taking α=4 yields the desired pattern: (4, 5, 6) is (qr, qnr, qnr).

### 5.1 EQZ Parameters

How large does the prime modulus need to be for EQZ to work with integers a of a fixed bit-size? The only relevant constraint is that FuzzyRound([a²/(a²+1)], 2, 1, κ) needs to be defined. In particular, using the constraints listed in Protocol 5 with

$${a}_{max} = {max}_{a} \{ \vert a \vert \} and ℓ = {log}_{2} ( {a}_{max}^{2} ) + 2$$

we obtain

$${2}^{- κ} N \geq 4 {a}_{max}^{2} + 4 {a}_{max}^{2} ( {a}_{max}^{2} + 1 ) + ( {a}_{max}^{2} + 1 ) = 4 {a}_{max}^{4} + 9 {a}_{max}^{2} + 1 \qquad Eq . 6$$

If |aₘₐₓ|=2^{η}−1, then taking log₂(N)=4η+κ+3 suffices. This results in a prime modulus of size log₂(p)≈8η+2κ+7.

### 6 Arithmetic Comparison

Before introducing the comparison protocol, we introduce two new protocols on which it relies.

### 6.1 Mod Reduction Protocols

Here we present two new protocols for computing mod reductions. The first is a probabilistic mod reduction which takes as inputs secret-shared integers a, b. The second is a mod 2 protocol, which computes a mod 2 for an integer input a.

Probabilistic mod reduction. Using FuzzyRound, we introduce a new protocol which computes a mod b for shared integers a, b∈ [symbol] _{N}. It is probabilistic in the sense that its output lies in either (−b, 0] or [0, b). Recall that for integers a, b with b>0,

$$a mod b = a - b ⌊ \frac{a}{b} ⌋ ∈ [ 0 , b ) \qquad Eq . 7$$

If we use FuzzyRound on [a/b] with precision k=0, then the output is either └a/b┘ or ┌a/b┘, depending on the value of the fractional part of a/b. Using Equation 7, we then get:

$$[ a ] - M u l t ( [ b ] , FuzzyRoun d ( [ a / b ] , B , 0 , σ ) ) = [ a mod b ] or [ ( a mod b ) - b ] . \qquad Eq . 8$$

From Equation 8, we get the following protocol.

Protocol 4: Secure probabilistic a modulo b.

```
      Inputs. Shares of (encodings of) integers a, b ∈ [symbol]   _{N}, and a security parameter σ.
      Constraints. a, b need to be small enough relative to N so that FuzzyRound([a/
b], B, 0, σ) is defined.
```

| | |
|---|---|
| | [f] ← FuzzyMod([a], [b], σ) |
| 1. | [a/b] = Div([a], [b]); |
| 2. | [f] = FuzzyRound([a/b], B, 0, σ); // The value of B is irrelevant here |
| 3. | [m] = [a] − Mult([b], [f]); |
| 4. | return [m]. |
| Invocations. | Online: 3 Mult, 2 Recon. |
| | Offline: 1 RandInt( ), 1 RandInt( [symbol] ), 1 RandInt(σ). |

Mod 2 protocol. This protocol relies on the fact that FuzzyMod can be modified to accept a public modulus. The modification is defined by

$$F u z z y M o {d}_{p u b} ( [ a ] , b , σ ) = [ a ] - ( b \cdot FuzzyRound ( [ a ] / b , B , 0 , σ ) ) . \qquad Eq . 9$$

The division and multiplication in steps 1 and 3 of FuzzyMod are replaced by division by a public value and multiplication by a public value. Since the latter two operations can be performed locally, FuzzyMod_{pub} only requires one invocation of FuzzyRound—one Mult, and RandInt( [symbol] ), RandInt(σ). Notice that if we take b=2, the fact that FuzzyMod_{pub} and FuzzyMod have the same range implies:

$$F u z z y M o {d}_{p u b} ( [ a ] , 2 , σ ) = \{ \begin{matrix}\pm 1 , & if a is odd \\ 0 , & if a is even\end{matrix} \qquad Eq . 10$$

Thus, to compute a mod 2, we simply need to use Equation 10 and then square the result.

Protocol 5: Secure a mod 2.

| | |
|---|---|
| Inputs. | Shares of (encodings of) integer a ∈ [symbol] _{N}, and a security parameter σ. |
| Constraints. | a needs to be small enough relative to N so that FuzzyRound([a/2], B, 0, σ) |
| | is defined. |
| | [f] ← Mod2([a], σ) |
| 1. | [f] = FuzzyMod_{pub}([a], 2, σ); |
| 2. | [b] = Mult([f], [f]); |
| 3. | return [b] = [a mod 2]. |
| Invocations. | Online: 1 Mult, 1 Recon. |
| | Offline: 1 RandInt( [symbol] ), 1 RandInt(σ). |

### 6.2 the Comparison Protocol

We first introduce a restricted version of the protocol that requires the input to be a quadratic residue, then generalize so that the input may be a residue or a non-residue.

Protocol 6: Greater-than-zero test for quadratic residues.

```
Inputs. Shares of an integer a ∈ [symbol]  _{N}, and a security parameter σ.
$Constraints . a \neq 0 , p = 3 mod 4 , p = 7 mod 8 , ( \frac{a}{p} ) = 1 , and {( 2 a )}^{2} + 1 < N small$
            enough so that FuzzyMod([(2a − 1)²], [(2a)² + 1], σ) is defined.
      [(a >^{?} 0)] ← QResGTZ([a], σ).
1. [α] = 2[a];
2. [α²] = Mult([α], [α]);
3. compute [2α] = 2[α], [α² + 1] = [α²] + 1, and [(α − 1)²] = [α² + 1] − [2α];
4. [f] ← FuzzyMod([(α − 1)²], [α² + 1], σ);
5. [ [symbol] ] = Legendre([f]);
6. [b] = (1 − [ [symbol] ])/2;
7. [m] = [f] + Mult([b], [α² + 1]);
8. [s] = Mod2([m]);
9. return [s] = [(a >^{?} 0)].
Invocations. Online: 7 Mult, 4 Recon.
              Offline: 2 Mult, 1 RandBit( ), 2 RandInt( ), 2 RandInt( [symbol] ), 2 RandInt(σ).
```

Theorem 2 (Correctness of Quadratic Residue Comparison). The restricted comparison protocol QResGTZ is correct.

Proof. Suppose the secret-sharing modulus p is prime, and that p=3 mod 4 and p=7 mod 8. First observe that α>0⇒(α−1)² mod(α²+1)=(α−1)² and α<0⇒(α−1)² mod(α²+1)=2α. From Equation 8 and the fact that 2α<α²+1, we obtain:

$$f = F u z z y M o d ( [ {( α - 1 )}^{2} ] , [ {α}^{2} + 1 ] , σ ) = \{ \begin{matrix}\begin{matrix}{( α - 1 )}^{2} \\ - 2 α \\ 2 α \\ - {( α - 1 )}^{2}\end{matrix} & \begin{matrix}if α > 0 \\ if α < 0\end{matrix}\end{matrix} \qquad Eq . 11$$

Notice that −2α and −(α−1)² are “incorrect” outputs in the sense that they are of the form “(x mod y)−y” instead of “x mod y”.

Since p=7 mod 8 and p=3 mod 4, 2 is a quadratic residue mod p, and for any integer z such that płz only one of z and −z is a quadratic residue mod p. Since a was chosen to be a quadratic residue mod p and 2 is also a quadratic residue, −2α is a quadratic non-residue. Further, (α−1)² is clearly a quadratic residue, so −(α−1)² is a quadratic non-residue. Let

$$ℓ = ( \frac{f}{p} ) . b = ( 1 - ℓ ) / 2$$

is a bit which is set to 1 if f is a quadratic non-residue mod p, and 0 otherwise. This bit allows us to correct the output of FuzzyMod if necessary i.e. convert ((α−1)² mod α²+1)−(α²+1) to (α−1)² mod α²+1. It follows that

$$m = f + b ( {α}^{2} + 1 ) = \{ \begin{matrix}{( α - 1 )}^{2} , & if α > 0 \\ 2 α , & if α < 0\end{matrix} \qquad Eq . 12$$

α=2a is even, so (α−1)² is odd. Consequently, (α>^{?}0)=m mod 2. The result follows since a and α have the same sign.

QResGTZ can be generalized to accept inputs which are quadratic non-residues with the addition of a few simple steps.

Protocol 7: General greater-than-zero test.

```
Inputs. Shares of an integer a ∈ [symbol]  _{N}, and a security parameter σ.
$Constraints . a \neq 0 , p = 3 mod 4 , p = 7 mod 8 , ( \frac{a}{p} ) = 1 , and {( 2 a )}^{2} + 1 < N small$
          enough so that FuzzyMod([(2a − 1)²], [(2a)² + 1], σ) is defined.
      [(a >^{?} 0)] ← GTZ([a], σ).
1. [l] = Legendre([a]);
2. [a′] = Mult([l], [a]);
3. [b] = QResGTZ([a′], σ);
4. [s] = 2[b] − 1;
5. [b′] = (1 + Mult([s], [l]))/2;
6. return [b′] = [(a >^{?} 0)].
Invocations. Online: 10 Mult, 5 Recon.
              Offline: 4 Mult, 2 RandBit( ), 3 RandInt( ), 2 RandInt( [symbol] ), 2 RandInt(o).
```

Corollary 2 (Correctness of GTZ). The comparison protocol GTZ is correct.

Proof. Since the secret-sharing prime is congruent to 3 modulo 4, the product

$${a}^{′} = a \cdot ( \frac{a}{p} ) ,$$

where pła, is always a nonzero quadratic residue modulo p. b=QResGTZ([a′], σ) is 1 if a′>0 and 0 if a′<0. This is the output we want if a and a′ have the same sign—i.e. if

$$( \frac{a}{p} ) = 1.$$

### However, if

$$( \frac{a}{p} ) = - 1 ,$$

then a and a′ have opposite signs. First note that s=2b−1 is 1 when a>0 and −1 when a<0.

Case 1:

$$l = ( \frac{a}{p} ) = 1.$$

b′=(1+s)/2=b=(a′>^{?}0). Since a, a′ have the same sign, b′=(a>^{?}0).

Case 2:

$$l = ( \frac{a}{p} ) = - 1.$$

b′=(1−s)/2=1−b=1−(a′>^{?}0). Since a, a′ have opposite signs, b′=(a>0).

This completes the proof.

As with EQZ, one may ask how to find primes which enable GTZ—namely, primes which are congruent to 3 modulo 4 and 7 modulo 8. This turns out to be quite easy. In fact, the Mersenne primes 2¹²⁷−1 and 2⁶⁰⁷−1 from section 5 both work.

### 6.3 GTZ Parameters

The only relevant constraint is that FuzzyMod([(2a−1)²], ((2a)²+1), σ) must be defined, which means that FuzzyRound([(2a−1)²/((2a)²+1)], B, 0, σ) must be defined. Let

$${a}_{max} = {max}_{a} \{ \vert a \vert \} .$$

Taking [symbol] =log₂((2aₘₐₓ−1)²) we obtain

$${2}^{- σ} N \geq {( 2 {a}_{max} - 1 )}^{2} + {( 2 {a}_{max} - 1 )}^{2} ( {( 2 {a}_{max} )}^{2} + 1 ) + ( {( 2 {a}_{max} )}^{2} + 1 ) \qquad Eq . 13$$

If aₘₐₓ=2^{η}−1, then 2^{σ}N=2^{4η+5} satisfies Equation 13. This results in a prime modulus of size log₂(p)≈8η+2σ+11.

### 7 Security of FuzzyRound, EQZ, and GTZ

As discussed in section 2.1, our protocols inherit the security of the functionalities they use − [symbol] _{ABB} and those for generating randomness—as long as any values revealed during the protocols is statistically indistinguishable from random. For example, in both HgDiv and Legendre, a value of the form “random×secret” is revealed. This does not reveal any information about the secret, if s∈ [symbol] ₚ is fixed and r [symbol] ₚ, then rs is uniformly random in [symbol] ₚ. Consequently, HgDiv and Legendre inherit the security of the functionalities.

The only other time a value is revealed that could leak information about a secret is in step 4 of FuzzyRound where an additively-masked secret is revealed. However, by lemma 3 the statistical distance between the distribution of the revealed value and the uniform distribution over the range of the revealed value is negligible in the security parameter σ. This result, along with Canetti's composition theorem, implies that FuzzyRound, EQZ, and GTZ are as secure as the functionalities they use.

### 8 Field Size and Rational Secrets

Use the derived parameters, we show what size of prime modulus is required for various sizes of inputs to EQZ and GTZ. We also show, as promised in section 3.3, how to select the subset [symbol] ⊆ [symbol] in order to ensure correctness of protocols. Specifically, choosing [symbol] to be a set of fixed-point numbers of various sizes and precisions will be discussed.

8.1 how Large does [symbol] ₚ Need to Be?

Recall that both EQZ and GTZ take as input integers in [symbol] _{N}. Moreover, since [−N, N]∩ [symbol] is the set of all integers in [symbol] _{N}, the integer inputs must be chosen small enough so that computations (e.g. step 2 in Protocol 6) do not overflow [symbol] _{N}. In table 1, we use the parameters provided in sections 5.1 and 6.3 to estimate the size of prime modulus required for EQZ and GTZ to work with integers of various bit sizes and values of the security parameter σ.

TABLE 1
Approximate values for log₂(p), where p is the secret sharing modulus,
for inputs with absolute value up to 2^{η} − 1 for various
values of η and the security parameter σ. E.g. GTZ with 32-bit integer
inputs and σ = 40 requires a field [symbol] ₚ with log₂(p) ≈ 347.

| | |
|---|---|
| σ = 30 | σ = 40 |

| Input Size η | EQZ | GTZ | EQZ | GTZ |
|---|---|---|---|---|
| 8 | 131 | 135 | 151 | 155 |
| 16 | 195 | 199 | 215 | 219 |
| 32 | 323 | 327 | 343 | 347 |
| 64 | 579 | 583 | 599 | 603 |

### 8.2 Rational Secrets: Fixed-Point Numbers

Fixed-point numbers are rational numbers represented as a list of digits split by a radix point, and are defined by an integer in a given range represented in some base b along with a fixed scaling factor f (called the precision). In particular, we can represent binary fixed-point numbers with integral part in the range (−2^{l+1}, 2^{l+1}) and up to f decimal places after the radix point as a·2^{-f}=a/2^{f}, a∈(−2^{l+f+1}, 2^{l+f+1}). This set will be denoted by FX_{l,f}, the (1+f)-bit binary fixed-point numbers with f-bit bit precision.

Observe that, [symbol] _{N}⊃FX_{l,f} as long as N≥2^{l+f+1}−1. It follows easily that the Mercury protocols paired with FuzzyRound yield protocols for multiplication and division of fixed-point numbers. The online cost for fixed-point multiplication is 1 Mult and 1 Recon. For fixed-point division, it is 2 Mult and 2 Recon. It turns out that using the field sizes given in table 1 is sufficiently large to enable these fixed-point operations. In particular, parameters which allow EQZ and GTZ to work with η-bit integer inputs also allow fixed-point multiplication and division over FX_{l,f} as long as 1+f=η.

### 9 Complexities with Shamir Secret Sharing

Suppose the underlying LSSS is Shamir's (t+1)-out-of-n secret-sharing scheme with an honest majority of semi-honest parties. Henceforth, n denotes the number of parties, and t+1 the reconstruction threshold: any t+1 parties can obtain the secret, but any t or fewer can learn nothing about the secret.

We assume that the “reconstruct” protocol Recon reveals a secret s as follows: any t+1 parties send their share of s to every other party so each party has at least t+1 shares, then each party reconstructs s locally. Recon requires 1 online round and has online communication complexity (t+1)(n−1) field elements. Mult is realized by the the protocol of Gennaro et al. This version of Mult takes 1 online round, has communication complexity (2t+1)(n−1) field elements, and requires t<n/2.

An Optimization. The aforementioned multiplication in Shamir's scheme requires the parties to multiply their shares locally, increasing the number of shares required for reconstruction from t+1 to 2t+1. They then perform 1 round of communication to reduce the reconstruction threshold back to t+1. In the case that a protocol requires a multiplication followed immediately by a reconstruction, which requires 2 online rounds, we can reduce the complexity to 1 online round at the cost of slightly increasing the communication complexity. This is done by performing the local multiplication, and then reconstructing with 2t+1 parties instead of t+1. The communication complexity increases from (t+1)(n−1) to (2t+1)(n−1). This optimization makes the online round complexities of Legendre and HgDiv to 1 and 2, respectively. Consequently, the online rounds required for EQZ and GTZ using Shamir's scheme are 5 and 11, respectively.

Using the communication complexities of above protocols, we obtain the communication complexities of EQZ and GTZ.

TABLE 2
Online communication (measured in field elements sent by
all parties) for the equality and comparison protocols.

| Protocol | Shamir's Scheme Online Comm. |
|---|---|
| EQZ | (9t + 5)(n − 1) |
| GTZ | (22t + 12)(n − 1) |

The complexities listed in table 2 do not paint a complete picture of the online communication complexities of EQZ and GTZ. In particular, we must combine the field sizes listed in table 1 with the communication complexities in table 2. Table 3 does exactly this, and lists the communication complexities of EQZ and GTZ in kilobytes (KB). For us, 1 kilobyte is 1000 bytes. To convert to 1 KB=1024 B, multiply the communication complexities in Table 3 by 1000/1024≈0.98.

TABLE 3
Estimated online communication in KB between all
parties during EQZ and GTZ using 2-out-of-3 Shamir
secret sharing and security parameter σ = 40.

| Input Size (bits) | 8 | 16 | 32 | 64 |
|---|---|---|---|---|
| EQZ | 0.528 | 0.753 | 1.201 | 2.097 |
| GTZ | 1.318 | 1.862 | 2.950 | 5.126 |

In general, using honest-majority Shamir's scheme with passive adversaries both EQZ and GTZ have online communication complexity O(tn log₂(p)) bits. Of course, this could change depending on the protocols chosen to realize Mult and Recon.

### 10 Conclusion and Future Work

Conclusions. We have presented three novel arithmetic protocols intended for multi-party computation from secret-sharing: FuzzyRound, EQZ, and GTZ. FuzzyRound is a probabilistic rounding protocol that approximates a secret Farey rational x/y by z/B^{k}, where B and k are public values which can be chosen to suit the desired application. The remaining two protocols, EQZ and GTZ, use FuzzyRound along with a quadratic residue test protocol to, respectively, securely test whether an integer is equal to zero or positive. Notably, EQZ and GTZ do not depend on the binary representation of their inputs.

### A: Proof of Lemma 4

Proof. Clearly every element of [symbol] ₚ is qr or qnr. It is well-known that [symbol] ₚ contains (p+1)/2 qr and (p−1)/2 qnr. Moreover, since p=3 mod 4, if a∈ [symbol] ₚ is nonzero, then one of a, −a is qr and the other is qnr. Equivalently, [symbol] (−x)= [symbol] (x).
(i) This follows immediately from properties of congruences.
(ii) x [symbol] +x+c is a bijection from [symbol] ₚ to [symbol] ₚ, so

$${\sum }_{x = 1}^{p} 𝒳 ( x + c ) = {\sum }_{x = 1}^{p} 𝒳 ( x ) = {\sum }_{x = 1}^{( p - 1 ) / 2} 𝒳 ( x ) + 𝒳 ( - x ) = 0 .$$

(iii)

$${\sum }_{x = 1}^{p} 𝒳 ( f ( x ) ) = {\sum }_{x = 1}^{( p - 1 ) / 2} 𝒳 ( f ( x ) ) + 𝒳 ( f ( - x ) ) = {\sum }_{x = 1}^{( p - 1 ) / 2} 𝒳 ( f ( x ) ) + 𝒳 ( - f ( x ) ) = 0 .$$

(iv) Say f(x)=x²+bx+c=4⁻¹((2x+b)²−(b²−4c)). If the discriminant b²−4c≠0, then we can rewrite f as f(x)=4⁻¹(X²−D) where D is nonzero. Since 4⁻¹=(2⁻¹)² is always qr,

$${\sum }_{x = 1}^{p} 𝒳 ( f ( x ) ) = {\sum }_{x = 1}^{p} 𝒳 ( {X}^{2} - D ) .$$

Now, consider the equation

$${Y}^{2} = {X}^{2} - D , where X , Y ∈ {𝔽}_{p} . \qquad Eq . 14$$

This is equivalent to (X−Y)(X+Y)=D. Now, the mapping (X, Y) [symbol] (u=X−Y, v=X+Y) is given by the matrix

$$M = [ \begin{matrix}1 & 1 \\ 1 & - 1\end{matrix} ] .$$

Since p≠2, det(M)=−2≠0, which means the mapping is bijective. Consequently, the number of solutions (X, Y) of Equation 14 is the same as the number of solutions (u, v) of uv=D. For each u≠0, there is only one v such that uv=D, whence Equation 14 has exactly p−1 solutions. On the other hand, for a fixed X, the number of solutions (X, Y) of Equation 14 is: 0 if X²−D is qnr, 1 if X²−D=0, and 2 if X²−D a qr. So the number of solutions for a fixed Y is given succinctly as 1+ [symbol] (X²−D). This implies that the number of solutions of Equation 14 is

$${\sum }_{x = 1}^{p} ( 1 + 𝒳 ( {X}^{2} - D ) ) .$$

But because the aforementioned mapping is a bijection each solution of Equation 14 corresponds to a solution of uv=D. Consequently,

$$p - 1 = {\sum }_{x = 1}^{p} ( 1 + 𝒳 ( {X}^{2} - D ) ) ,$$

which implies

$${\sum }_{x = 1}^{p} 𝒳 ( {X}^{2} - D ) = - 1 .$$

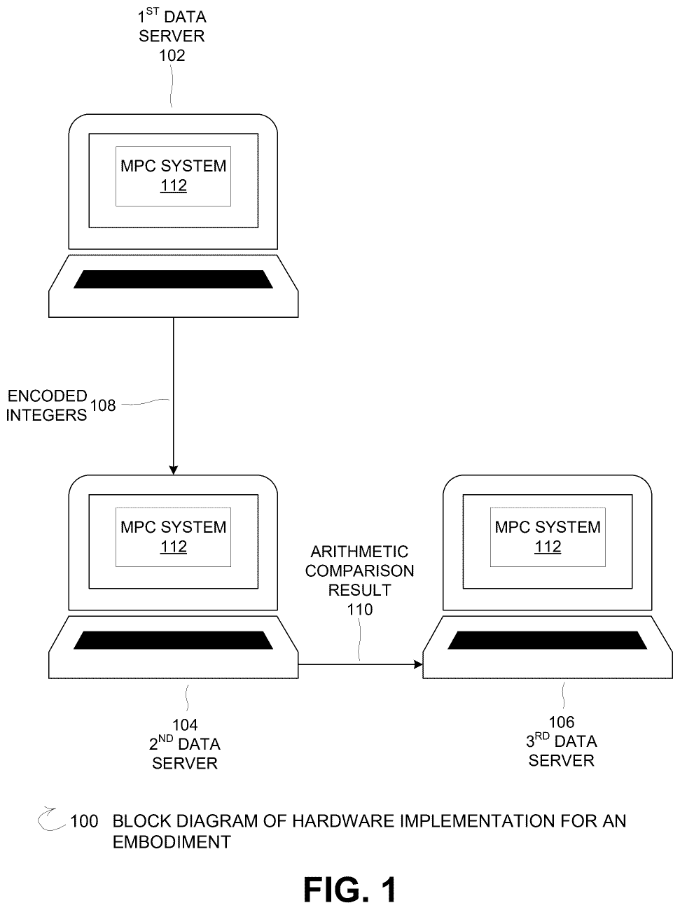

### Hardware Implementation for an Embodiment (FIG. 1)

FIG. 1 is a block diagram 100 of the hardware implementation for an embodiment. A 1^{st} data server computing device 102 is connected over an electronic network/bus connection 108 to a 2^{nd} data server computing device 104. The 2nd data server computing device 104 is further connected over an electronic network/bus connection 110 to a 3^{rd} data server computing device 106. Each of the data server computing devices are running the Multi-Party Computation (MPC) system 112.

In the embodiment shown in FIG. 1, the 1^{st} data server computing device 102 acts as the source of the encoded integer(s) 108 and the 1^{st} data server computing device 102 sends the encoded integer(s) 108 over the network/bus connection 108 to the 2^{nd} data server computing device 104. For the use of the arithmetic comparison of the encoded initial rational number by a second rational, the 1^{st} data server computing device 102, encodes the second rational number into a second encoded integer and sends the second rational number 108 to the 2^{nd} data server computing device 104.

The encoded integer(s) 108 start at the 1^{st} data server computing device as rational numbers, which may be in fixed-point format. An embodiment at the 1^{st} data server computing device 102 encodes the rational numbers into the corresponding encoded integer(s) 108 as a function of in the domain of Farey rationals.

Generally, communications, including concealed/encrypted communications, are bi-directional and may be connected between any of the data server computing devices 102-106, such that data server computing devices 102-106 may change roles as is necessary to accommodate the transfer of data back and forth between the data server computing devices 102-106. Additionally, while the data server computing devices 102-106 are depicted as separate devices in FIG. 1, the functionality of the data server computing devices 102-106 may be shared on a single computing system/device or among two or more computing devices.

Further, as shown in FIG. 1, the data server computing devices 102-106 appear to be laptop computers, but any computing device or system may be satisfactory. Generally, any computing device capable of communication over any form of electronic network or bus communication platform may be one or more of the data server computing devices 102-106. Additionally, data server computing devices 102-106 may actually be the same physical computing device communicating over an internal bus connection with itself.

Various embodiments may implement the network/bus communications channel 108-110 using any communications channel 108-110 capable of transferring electronic data between the data server computing devices 102-106. For instance, the network/bus communication connection 108-110 may be an Internet connection routed over one or more different communications channels. Likewise, the network/bus communication connection 108-110 may be an internal communications bus of a computing device, or even the internal bus of a processing or memory storage Integrated Circuit (IC) chip, such as a memory chip or a Central Processing Unit (CPU) chip. The network/bus communication channel 108-110 may utilize any medium capable of transmitting electronic data communications, including, but not limited to: wired communications, wireless electro-magnetic communications, fiber-optic cable communications, light/laser communications, sonic/sound communications, etc., and any combination thereof of the various communication channels.

The various embodiments may provide the control and management functions detailed herein via an application operating on the data server computing devices 102-106. The data server computing devices 102-106 may each be a computer or computer system, or any other electronic devices capable of performing the communications and computations of an embodiment. The data server computing devices 102-108 may include, but are not limited to: a general-purpose computer, a laptop/portable computer, a tablet device, a smart phone, an industrial control computer, a data storage system controller, a CPU, a Graphical Processing Unit (GPU), an Application Specific Integrated Circuit (ASIC), and/or a Field Programmable Gate Array (FPGA). Notably, the data server computing devices 102-106 may be the storage controller of a data storage media (e.g., the controller for a hard disk drive). Embodiments may be provided as a computer program product which may include a computer-readable, or machine-readable, medium having stored thereon instructions which may be used to program/operate a computer (or other electronic devices) or computer system to perform a process or processes in accordance with the various embodiments. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

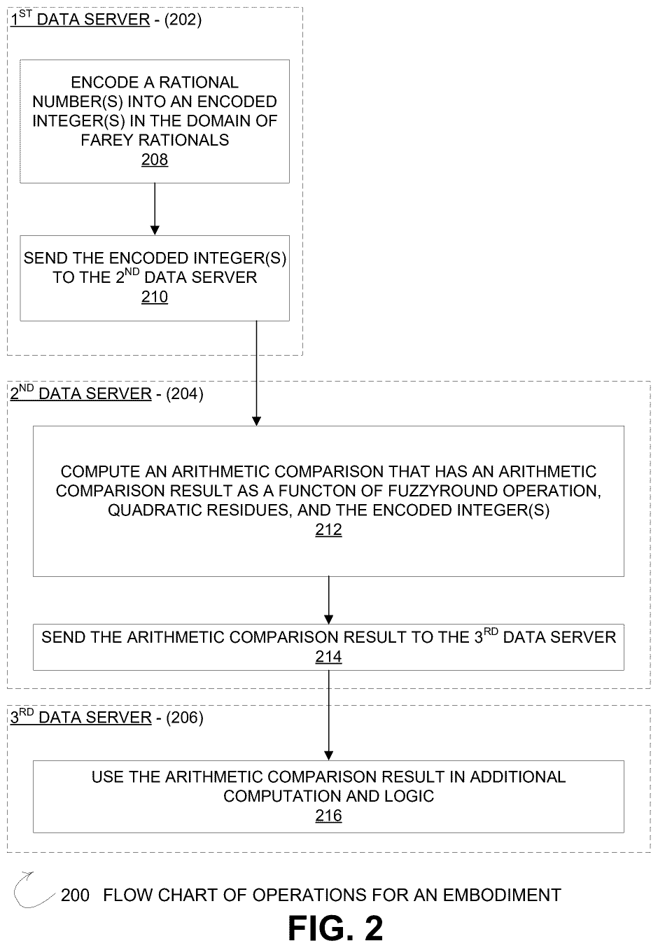

### Operational Flow Chart for an Embodiment (FIG. 2)

FIG. 2 is a flow chart 200 of operations for an embodiment. At process 208, the 1^{st} data server computing device 202 encodes one or more rational numbers into corresponding encoded integers in the domain of Farey rationals. At process 210, the 1^{st} data server computing device 202 sends the encoded integers to the 2nd data server computing device 204. At process 212, the 2^{nd} data server computing device 204, computes an arithmetic comparison result as of function of FuzzyRound operation, quadratic residues, and the encoded integers. Embodiments securely provide for evaluation of encoded rational numbers for arithmetic equality equal to zero or not, probabilistic modulo of two rational numbers, probabilistic modulo of a rational number by a public value of two, a test for whether a rational number is greater-than-zero for quadratic residues and a general greater-than-zero test for a rational number which are quadratic non-residues.

At process 214, the 2^{nd} data server computing device 204 sends the arithmetic comparison result to the 3^{rd} data server computing device 206. At process 216, the 3^{rd} data server computing device uses the arithmetic comparison result in additional computation and logic.

Additionally, while the flow charts and flow chart details described above with respect to FIG. 2 describe a methodology that may be embodied as a method or process, another embodiment may be recognized as a computer system, and/or as an intermediary computing device that stores and/or performs homomorphic operations of encrypted data by implementing the processes described above with respect to the flow chart and flow chart details of FIG. 2. Further, in describing the computing system, and/or any intermediary computing system, one, or more, individual processes described above for the methodology may be broken down and represented as a subsystem of the overall encryption computer system. A subsystem of the computer system, in whole or in part, may be assigned to a particular hardware implemented system, such as a dedicated Application Specific Integrated Circuit (ASIC) or Field Programmable Gate Array (FPGA). One or more subsystems, in whole or in part, may alternatively be implemented as software or firmware instructions defining the operation of a computer system with specific regard to the one or more subsystems implemented as software or firmware instructions. The software or firmware instructions may cause the Central Processing Unit, memory, and/or other systems of a computer system to operate in particular accordance with the particular one or more subsystems designated features.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated.

What is claimed is:

1. A method for Multi-Party Computation (MPC) arithmetic comparison on a Multi-Party Computation (MPC) system of rational data encoded in a domain of Farey rationals, the method comprising:
encoding by a first data server computing device a rational number into an encoded integer corresponding to said rational number as an encode function in said domain of Farey rationals;
sending by said first data server computing device said encoded integer to a second data server computing device;
computing by said second data server computing device an arithmetic comparison that has an arithmetic comparison result as a function of a FuzzyRound operation, quadratic residues, and said encoded integer; and
sending by said second data server computing device said result encoded integer to a third data server computing device for use in additional computations and logic.

2. The method of claim 1 wherein said arithmetic comparison is an arithmetic equality as a function of said FuzzyRound operation, said quadratic residues, and said encoded integer such that said arithmetic comparison result is 0 when said encoded integer represents a 0 value for said rational number and a 1 when said encoded integer represents a non-zero value for said rational number.

3. The method of claim 1 wherein said arithmetic comparison is said rational number modulo a second rational number and further comprising:
encoding by said first data server computing device a second rational number into a second encoded integer corresponding to said second rational number as an encode function in said domain of Farey rationals;
sending by said first data server computing device said second encoded integer to said second data server computing device; and
wherein said computing by said second data server computing device of said arithmetic comparison said arithmetic comparison result is said rational number modulo said second rational number as a function of a FuzzyRound operation, quadratic residues, said encoded integer, and said second encoded integer.

4. The method of claim 1 wherein said arithmetic comparison is said rational number modulo public modulus 2 as a function of said FuzzyRound operation, said quadratic residues, said encoded integer and said public modulus 2.

5. The method of claim 1 wherein said arithmetic comparison is a greater-than-zero test for said quadratic residues as a function of said FuzzyRound operation, said quadratic residues, and said encoded integer.

6. The method of claim 1 wherein said arithmetic comparison is a general greater-than-zero test for said encoded integer as a function of said FuzzyRound operation, said quadratic residues, and said encoded integer and said encoded integer is quadratic non-residue.

7. The method of claim 1 wherein said FuzzyRound operation is a probabilistic rounding protocol for rational numbers in said domain of Farey rationals.

8. The method of claim 1 wherein said rational data is comprised of a fixed-point integer representation of fractional data.

9. An arithmetic comparison system that operates as part of a Multi-Party Computation (MPC) system, the arithmetic comparison system comprising:
a first data server computing device that encodes a rational number into an encoded integer corresponding to said rational number as an encode function in said domain of Farey rationals and sends said encoded integer to a second data server computing device; and
said second server computing device that computes an arithmetic comparison that has an arithmetic comparison result as a function of a FuzzyRound operation, quadratic residues, and said encoded integer and sends said result encoded integer to a third data server computing device for use in additional computations and logic.

10. The arithmetic comparison system of claim 9 wherein said arithmetic comparison is an arithmetic equality as a function of said FuzzyRound operation, said quadratic residues, and said encoded integer such that said arithmetic comparison result is 0 when said encoded integer represents a 0 value for said rational number and a 1 when said encoded integer represents a non-zero value for said rational number.

11. The arithmetic comparison system of claim 9:
wherein said arithmetic comparison is said rational number modulo a second rational number;
wherein said first data server further encodes a second rational number into a second encoded integer corresponding to said second rational number as an encode function in said domain of Farey rationals and sends said second encoded integer to said second data server computing device; and
wherein said second data server computing device computes said arithmetic comparison of said arithmetic comparison result is said rational number modulo said second rational number as a function of a FuzzyRound operation, quadratic residues, said encoded integer, and said second encoded integer.

12. The arithmetic comparison system of claim 9 wherein said arithmetic comparison is said rational number modulo public modulus 2 as a function of said FuzzyRound operation, said quadratic residues, said encoded integer and said public modulus 2.

13. The arithmetic comparison system of claim 9 wherein said arithmetic comparison is a greater-than-zero test for said quadratic residues as a function of said FuzzyRound operation, said quadratic residues, and said encoded integer.

14. The arithmetic comparison system of claim 9 wherein said arithmetic comparison is a general greater-than-zero test for said encoded integer as a function of said FuzzyRound operation, said quadratic residues, and said encoded integer and said encoded integer is quadratic non-residue.

15. The arithmetic comparison system of claim 9 wherein said FuzzyRound operation is a probabilistic rounding protocol for rational numbers in said domain of Farey rationals.

16. The arithmetic comparison system of claim 9 wherein said rational data is comprised of a fixed-point integer representation of fractional data.
